(19) United States
(12) Patent Application Publication
(10) Pub. No.: US 2024/0008677 A1
(43) Pub. Date: Jan. 11, 2024

(54) BEVERAGE MAKING AND BLENDING DEVICE

(71) Applicant: WHIRLPOOL CORPORATION, Benton Harbor, MI (US)

(72) Inventors: Marcos Aurelio DE SOUZA, Saint Joseph, MI (US); Matheus UNGERICHT, Santo Augusto (BR); Henrique Keiji ARAI YAMAKI, Joinville (BR)

(21) Appl. No.: 17/858,622

(22) Filed: Jul. 6, 2022

(51) Int. Cl. A47J 31/40; B01F 23/40; B01F 35/93; B01F 35/221; B01F 35/71; A47J 31/46; A47J 31/56

(52) U.S. Cl. CPC A47J 31/407; B01F 23/40; B01F 35/93; B01F 35/2215; B01F 35/2216; B01F 35/7174; A47J 31/46; A47J 31/56; B01F 2035/99

(57) ABSTRACT

A beverage maker includes a receptacle, a piston, a fluid circuit, a first heater, and a second heater. The receptacle is configured to receive a flavoring capsule. The piston is configured to compress the flavoring capsule to direct flavoring fluid from the beverage flavoring capsule and into a container via a channel. The fluid circuit has an outlet configured to direct water into the container adjacent to the channel. The first heater is disposed within the receptacle and is configured to heat the beverage flavoring capsule. The second heater is disposed along the circuit and is configured to heat the water flowing through the circuit.

### TECHNICAL FIELD

The present disclosure relates to devices for making beverages.

### BACKGROUND

Water may be blended with other ingredients to produce various types of consumable beverages.

### SUMMARY

A beverage blending device includes a receptacle, a cover, a fluid circuit, a first heating element, a second heating element, and a controller. The receptacle is configured to receive a beverage flavoring capsule. The receptacle also defines a channel configured route flavoring fluid from the beverage flavoring capsule toward a container. The cover is configured to transition between a first position that covers the receptacle and a second position that exposes the receptacle. The fluid circuit has an outlet that is disposed proximate to the channel and is configured to route water from a source toward the container. The first heating element is disposed within the receptacle and is configured to heat the beverage flavoring capsule. The second heating element is disposed along the circuit and is configured to heat the water flowing through the circuit. The controller is programmed to, in response to a command to blend and dispense the flavoring fluid and the water, (i) operate the first heating element to heat the beverage flavoring capsule according to a first parameter, (ii) operate the second heating element to heat the water according to a second parameter, and (iii) subsequent to heating the beverage flavoring capsule and the water according to the first and second parameters, respectively, simultaneously dispense the flavoring fluid and the water into the container via the channel and the outlet, respectively.

A beverage maker includes a receptacle, an outlet, a first heater, a second heater, and a controller. The receptacle is configured to receive a flavoring capsule. The receptacle also defines a channel configured direct flavoring fluid from the flavoring capsule in a downward direction. The outlet is configured to direct the water in the downward direction adjacent to the channel. The first heater is configured to heat the flavoring capsule. The second heater is configured to heat the water. The controller is programmed to, in response to the receptacle receiving the flavoring capsule and a command to produce a hot beverage, (i) operate the first heater to heat the flavoring capsule according to a first parameter, (ii) operate the second heater to heat the water according to a second parameter, and (iii) dispense the heated flavoring fluid and the heated water via the channel and the outlet, respectively.

A beverage maker includes a receptacle, a piston, a fluid circuit, a first heater, and a second heater. The receptacle is configured to receive a flavoring capsule. The piston is configured to compress the flavoring capsule to direct flavoring fluid from the beverage flavoring capsule and into a container via a channel. The fluid circuit has an outlet configured to direct water into the container adjacent to the channel. The first heater is disposed within the receptacle and is configured to heat the beverage flavoring capsule. The second heater is disposed along the circuit and is configured to heat the water flowing through the circuit.

### BRIEF DESCRIPTION OF THE DRAWINGS

FIG. 1 is a front view of a beverage making and blending device having a receptacle configured to receive a beverage flavoring capsule, with a cover to the receptacle illustrated in an open position and having a beverage flavoring capsule disposed therein;

FIG. 2 is a front view of the beverage making and blending device with the cover to the receptacle illustrated in a closed position;

FIG. 3 is a front isometric view of a flavoring capsule dispensing assembly that includes the receptacle and the cover, with the cover in the open position and without a beverage flavoring capsule disposed within the receptacle;

FIG. 4 is cross-section view taken along line 4-4 in FIG. 3 with the cover in the closed position;

FIG. 5 is a partial isometric view of the beverage making and blending device with some of the external housing panels and the flavoring capsule dispensing assembly removed to illustrate various internal components of the beverage making and blending device;

FIG. 6 is a schematic diagram of a fluid circuit of the beverage making and blending device and an associated control system for the beverage making and blending device; and

FIG. 7 is flowchart illustration a method of controlling the beverage making and blending device.

### DETAILED DESCRIPTION

Embodiments of the present disclosure are described herein. It is to be understood, however, that the disclosed embodiments are merely examples and other embodiments may take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

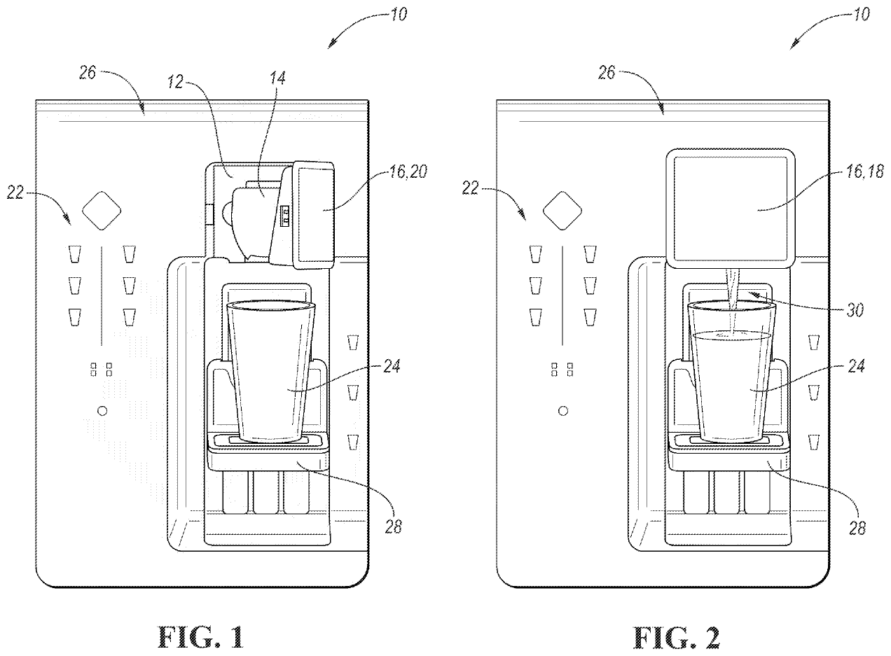

Referring to FIGS. 1 and 2, a beverage making and blending device or a beverage maker 10 is illustrated. The beverage maker 10 is configured to blend water and a flavoring fluid (e.g., a syrup or concentrated solution) to produce a beverage. The beverage maker 10 may be capable of producing cold beverages, hot beverages, and/or carbonated beverages. The beverage maker 10 includes a receptacle 12 that is configured to receive beverage flavoring capsules 14 that contain flavoring fluids. A cover 16 is disposed over the receptacle 12. The cover 16 is configured to transition between a first position 18 that covers the receptacle 12 and a second position 20 that exposes the receptacle 12. The first position 18 may be referred to as the closed position while the second position 20 may be referred to as the open position. A user or operator of the beverage maker may dispose an unused beverage flavoring capsule 14 in the receptacle 12 prior to making a beverage and may remove a spent or used beverage flavoring capsule 14 from the receptacle 12 after making the beverage when the cover 16 is in the second position 20.

In order to produce a beverage, the cover 16 is transitioned to the closed position with an unused beverage flavoring capsule 14 in the receptacle 12. The user then engages a control panel 22 to initiate the process. A piston compresses the unused beverage flavoring capsule 14 within the receptacle to dispense the flavoring fluid downward and toward a container 24 (e.g., a mug or cup). An outlet simultaneously dispenses water downward and toward the container 24. The flavoring fluid and water are mixed or blended together as each are direct downward into the container 24 to produce the desired beverage. The beverage flavoring capsules 14 may have different flavoring fluids to produce difference types of hot, cold, or carbonated beverages. For example, the beverage flavoring capsules 14 may contain flavoring fluids to make coffee, tea, various types of juice, soda pop, etc.

The control panel 22 may include various buttons, switches, knobs, dials, etc. that allow a user to select the type of beverage, start the beverage making process, pause the beverage making process, etc. The control panel 22 may also include a main power switch. The control panel 22 may be configured to communicate with a controller that operates the various components of the beverage maker 10 to produce the beverages. The control panel 22 may be disposed on the exterior of an outer housing 26 of the beverage maker 10. The receptacle 12 and the cover 16 may be secured to the housing 26. A platform 28 that is configured to support the container 24 may also be secured to the housing 26 and may be adjustable upwards or downward to adjust a distance between the container 24 and a dispensing area 30 along the bottom of the cover 16, where the flavoring fluid and water are dispensed downward and toward the container 24.

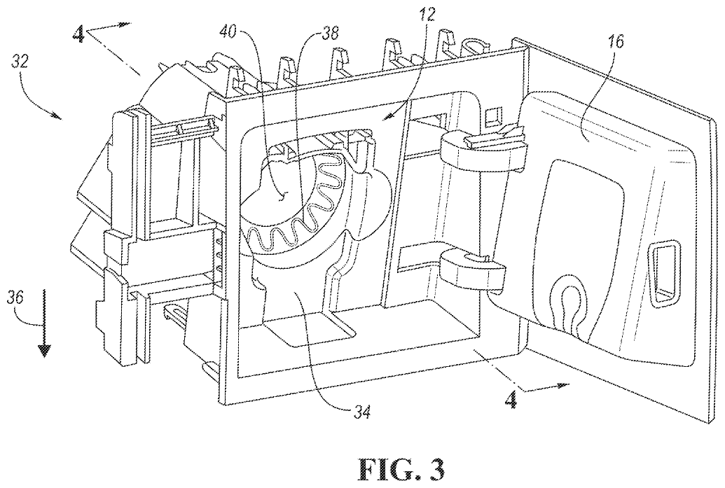

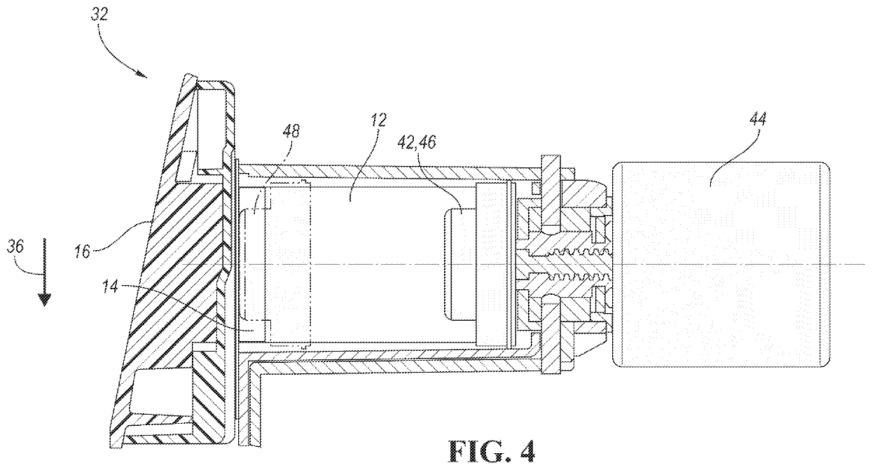

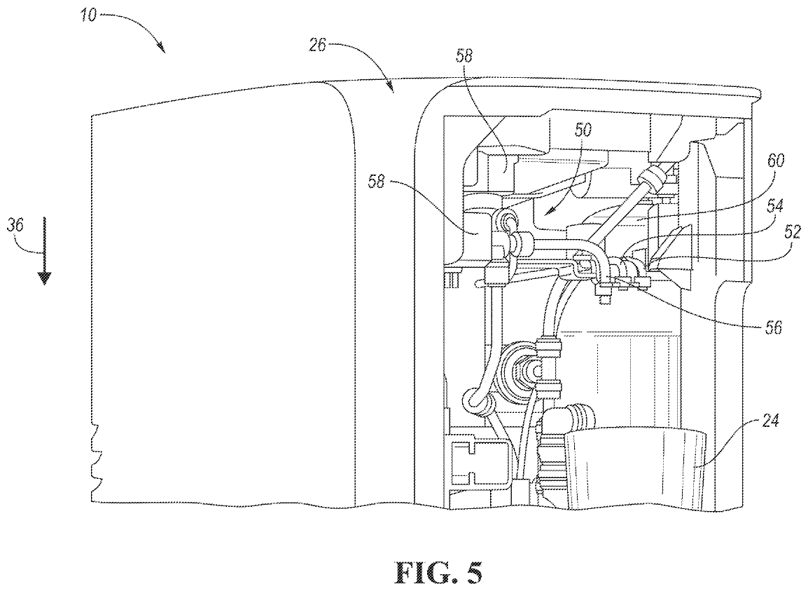

Referring to FIGS. 3 and 4, a flavoring capsule dispensing assembly 32 that includes the receptacle 12 and the cover 16 is illustrated. The receptacle 12 defines a channel 34 that is configured route flavoring fluid in a downward direction 36 from the beverage flavoring capsule 14 toward the container 24. A heating element or heater 38 may be secured to the flavoring capsule dispensing assembly 32. The heater 38 may be a flexible foil heater. The heater 38 is configured to heat the beverage flavoring capsule 14. The heater 38 may more specifically be disposed within the receptacle 12 along an inner circumference or an internal surface 40 of the receptacle 12 that surrounds or encompasses the beverage flavoring capsule 14 when received therein. The flavoring capsule dispensing assembly 32 further includes a piston 42 that is disposed within the receptacle 12. The piston 42 is configured to compress the beverage flavoring capsule 14 to direct flavoring fluid from the beverage flavoring capsule 14 into the channel 34 and eventually into the container 24 via the channel 34. An actuator 44 is configured to transition the piston 42 from a retracted position 46 to an advanced position 48 to compress the beverage flavoring capsule 14. The actuator 44 is illustrated as an electric motor. However, it should be understood that the actuator 44 may be any type of linear actuator (e.g., a linear electric motor, an electric solenoid, a hydraulic cylinder operated by an electric valve, a pneumatic cylinder operated by an electric valve, etc.).

Referring to FIG. 5, various internal components of the beverage maker 10 are illustrated. Some of the external panels of the housing 26 and the flavoring capsule dispensing assembly 32 have been removed to illustrate the various internal components. More specifically, a fluid circuit 50 that is configured to route water from a source toward the container 24 is illustrated. The water circuit includes several outlets that are disposed proximate or adjacent to the channel 34. The outlets are configured route water in the downward direction 36 toward the container 24. The water and the flavoring fluid being dispensed from the channel 34 are configured to mix or blend as the water and the flavoring fluid are directed toward and into the container 24. A first of the outlets 52 is configured to direct heated water toward the container 24, a second of the outlets 54 is configured to direct carbonated water toward the container 24, and third of the outlets 56 is configured to direct water that has not been heated and has not been carbonated toward the container 24. Various valves 58 are configured to control the water flow to the outlets. A pressure vessel 60 that adds carbonation (i.e., carbon dioxide) to the water being directed to the second of the outlets 54 may also be removably disposed within the housing 26.

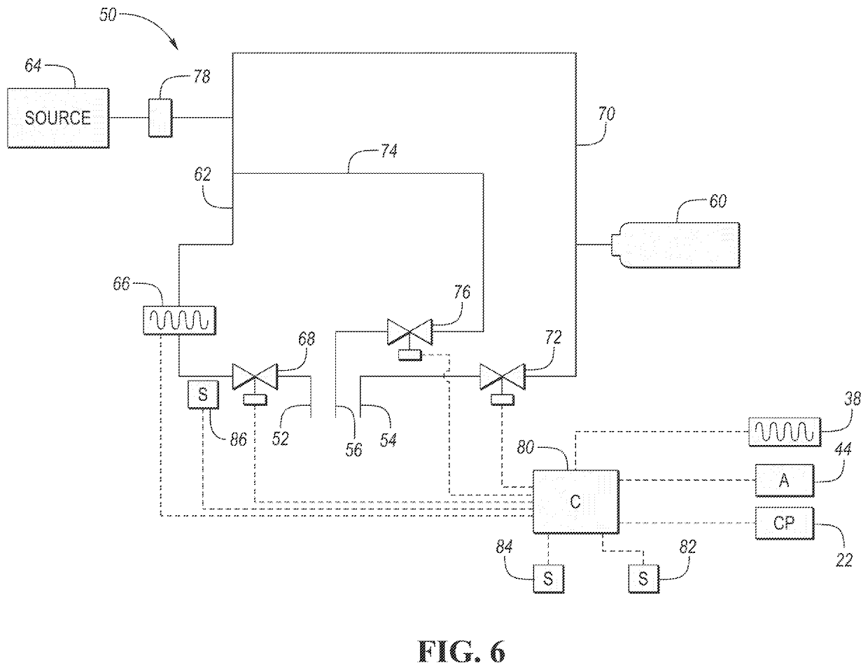

Referring to FIG. 6 a schematic diagram of the fluid circuit 50 and an associated control system for the beverage maker 10 are illustrated. The fluid circuit 50 includes a first path 62 that directs water from a source 64 to a heating element or heater 66 to heat the water, and then to the first outlet 52. The source 64 may be a domestic water supply or a storage tank. Such a storage tank may be either separate from or integral to the beverage maker 10. Domestic water supplies are typically pressurized negating the need for a pump. However, if the source 64 is a storage tank or if the domestic water supply does not provide sufficient pressure, a pump may be provided. Such a pump may be either separate from or integral to the beverage maker 10. A first valve 68 is configured to open and close to control water flow through the first path 62. The fluid circuit 50 includes a second path 70 that directs water from the source 64 to the pressure vessel 60 for carbonation, and then to the second outlet 54. A second valve 72 is configured to open and close to control water flow through the second path 70. The fluid circuit 50 includes a third path 74 that directs water from the source 64 to the third outlet 56. A third valve 76 is configured to open and close to control water flow through the third path 74. A filter 78 may be configured to purify the water being delivered to the fluid circuit 50 from the source 64. The filter 78 may be either separate from or integral to the beverage maker 10. The fluid circuit 50 may include additional control valves or circuits not illustrated in FIG. 6. For example, A shutoff valve may be disposed between the source 64 and the fluid circuit 50 wherein the shutoff valve is opened and closed to control water flow through each path (i.e., the first path 62, the second path 70, and the third path 74). As another example, an additional valve may be utilized to control the flow of carbon dioxide from the pressure vessel 60 into the water flowing through the second path 70.

A controller 80 is configured to operate the various components of the beverage maker 10 to produce a desired beverage. The controller 80 may be in communication with and configured to operate the heater 38, the actuator 44 (to control the position of the piston 42), the heater 66, the first valve 68, the second valve 72, and the third valve 76. More specifically, the valves (i.e., the first valve 68, the second valve 72, and the third valve 76) may include actuators, such as electric solenoids that are in communicating with and operated by the controller 80 to transition the valves between open and closed positions. The controller 80 may also be in communication with and configured to receive signals from the control panel 22 to operate various components of the beverage maker 10 to produce a desired beverage based on the signal received from the control panel 22. The control panel 22, the heater 38, the actuator 44, the heater 66, the first valve 68, the second valve 72, the third valve 76, and the controller 80 may also be connected to an electrical power source such as a power grid or a battery. Such a power source is not shown for illustrative purposes. More specifically, the actuators that operate the valves (i.e., the first valve 68, the second valve 72, and the third valve 76) may be connected to the electrical power source.

In response to receiving a signal from the control panel 22 to produce a hot beverage, the controller 80 may be programmed to activate the heater 66 to heat the water in the first path 62, activate the heater 38 to heat the beverage flavoring capsule 14, open the first valve 68 to dispense hot water from the first outlet 52, and activate the actuator 44 to transition the piston 42 to the advanced position 48 to compress the beverage flavoring capsule 14 to dispense the flavoring fluid from the channel 34. The controller 80 may also be configured to close or maintain closed positions of the second valve 72 and the third valve 76 in response to receiving the signal from the control panel 22 to produce a hot beverage such that water flows through the first path 62 and out of the first outlet 52, but not (i) through the second path 70 and out of the second outlet 54 or (ii) through the third path 74 and out of the third outlet 56. In the event a signal is received from the control panel 22 to dispense hot water only, the first valve 68 may be opened and heater 66 may be activated while heater 38 and actuator 44 remain in an “off” or shutdown state.

In response to receiving a signal from the control panel 22 to produce a carbonated beverage, the controller 80 may be programmed to open the second valve 72 to direct water toward the pressure vessel 60 for carbonation, dispense the carbonated water from the second outlet 54, and activate the actuator 44 to transition the piston 42 to the advanced position 48 to compress the beverage flavoring capsule 14 to dispense the flavoring fluid from the channel 34. The controller 80 may also be configured to close or maintain closed positions of the first valve 68 and the third valve 76 in response to receiving the signal from the control panel 22 to produce a carbonated beverage such that water flows through the second path 70 and out of the second outlet 54, but not (i) through the first path 62 and out of the first outlet 52 or (ii) through the third path 74 and out of the third outlet 56. In the event a signal is received from the control panel 22 to dispense carbonated water only, the second valve 72 may be opened while actuator 44 remains in an “off” or shutdown state.

In response to receiving a signal from the control panel 22 to produce a non-heated and non-carbonated beverage, the controller 80 may be programmed to open the third valve 76 to dispense the water from the third outlet 56, and activate the actuator 44 to transition the piston 42 to the advanced position 48 to compress the beverage flavoring capsule 14 to dispense the flavoring fluid from the channel 34. The controller 80 may also be configured to close or maintain closed positions of the first valve 68 and the second valve 72 in response to receiving the signal from the control panel 22 to produce a non-heated and non-carbonated beverage such that water flows through the third path 74 and out of the third outlet 56, but not (i) through the first path 62 and out of the first outlet 52 or (ii) through the second path 70 and out of the second outlet 54. In the event a signal is received from the control panel 22 to dispense non-heated and non-carbonated water only, the third valve 76 may be opened while actuator 44 remains in an “off” or shutdown state.

While illustrated as one controller, the controller 80 may be part of a larger control system and may be controlled by various other controllers throughout the beverage maker 10. It should therefore be understood that the controller 80 and one or more other controllers can collectively be referred to as a “controller” that controls various actuators in response to signals to control functions of the beverage maker 10. The controller 80 may include a microprocessor or central processing unit (CPU) in communication with various types of computer readable storage devices or media. Computer readable storage devices or media may include volatile and nonvolatile storage in read-only memory (ROM), random-access memory (RAM), and keep-alive memory (KAM), for example. KAM is a persistent or non-volatile memory that may be used to store various operating variables while the CPU is powered down. Computer-readable storage devices or media may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 80 in controlling the beverage maker 10.

Control logic or functions performed by the controller 80 may be represented by flow charts or similar diagrams in one or more figures. These figures provide representative control strategies and/or logic that may be implemented using one or more processing strategies such as event-driven, interrupt-driven, multi-tasking, multi-threading, and the like. As such, various steps or functions illustrated may be performed in the sequence illustrated, in parallel, or in some cases omitted. Although not always explicitly illustrated, one of ordinary skill in the art will recognize that one or more of the illustrated steps or functions may be repeatedly performed depending upon the particular processing strategy being used. Similarly, the order of processing is not necessarily required to achieve the features and advantages described herein, but is provided for ease of illustration and description. The control logic may be implemented primarily in software executed by a microprocessor-based controller, such as controller 80. Of course, the control logic may be implemented in software, hardware, or a combination of software and hardware in one or more controllers depending upon the particular application. When implemented in software, the control logic may be provided in one or more computer-readable storage devices or media having stored data representing code or instructions executed by a computer to control the beverage maker 10. The computer-readable storage devices or media may include one or more of a number of known physical devices which utilize electric, magnetic, and/or optical storage to keep executable instructions and associated calibration information, operating variables, and the like.

The controller 80 may be configured to receive various states or conditions of the various components illustrated in FIG. 6 via electrical signals. The electrical signals may be delivered to the controller 80 from the various components via input channels. Additionally, the electrical signals received from the various components may be indicative of a request or a command to change or alter a state of one or more of the respective components of the beverage maker 10. The controller 80 includes output channels that are configured to deliver requests or commands (via electrical signals) to the various components. The controller 80 includes control logic and/or algorithms that are configured to generate the requests or commands delivered through the output channels based on the requests, commands, conditions, or states of the various components.

The input channels and output channels are illustrated as dotted lines in FIG. 6. It should be understood that a single dotted line may be representative of both an input channel and an output channel into or out of a single element. Furthermore, an output channel out of one element may operate as an input channel to another element and vice versa.

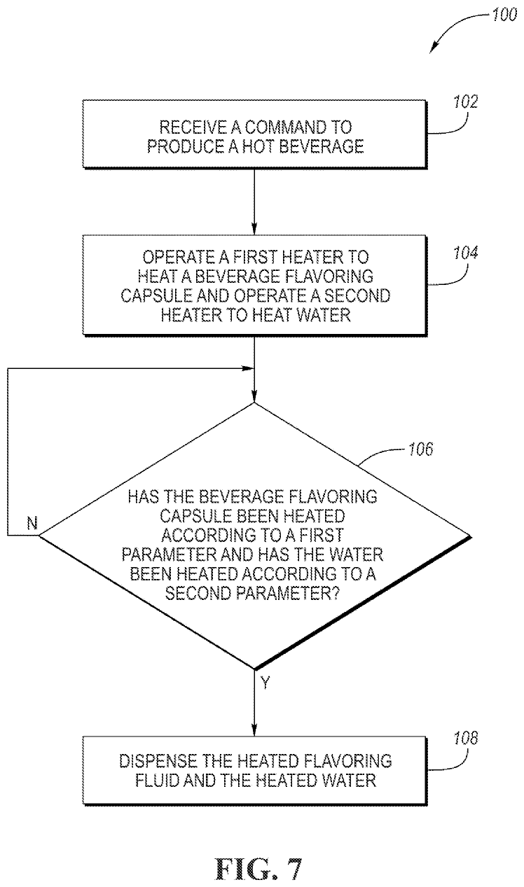

Referring to FIG. 7, a flowchart illustrating a method 100 for controlling the beverage maker 10 is illustrated. The method 100 may be implemented by the controller 80. The method 100 may be stored as control logic and/or algorithms within the controller 80. The controller may be configured to control the operation of various components of the beverage maker 10 in response to various commands received by the controller 80. The method 100 begins at block 102 once a signal is received to produce a hot beverage. Such a signal may be received by the controller and may correspond to a command received from the control panel 22 to blend and dispense flavoring fluid from the beverage flavoring capsule 14 and hot water from the channel 34 and the first outlet 52, respectively. Also, at block 102, a secondary signal may be required that is indicative that a beverage flavoring capsule 14 has been placed in the receptacle 12 before the method 100 may be initiated at block 102. Such a signal that a beverage flavoring capsule 14 has been placed in the receptacle 12 may be received from a sensor 82. Sensor 82 may be an optic sensor that reads the type of capsule based on a code (e.g., barcode or QR code) that is printed on the beverage flavoring capsule 14, a sensor that detects the presence of the beverage flavoring capsule 14 in the receptacle 12 (e.g., a proximity sensor), or a sensor that detected that the cover 16 was opened and then closed.

If sensor 82 is configured to read a code printed on the beverage flavoring capsule 14, the sensor 82 may also be configured to communicate the code printed on the beverage flavoring capsule 14 to the controller 80. The code may include information indicative of the type of beverage that is to be prepared. The controller 80 may then control heating the water or carbonating the water in preparation of making the beverage based on the type of beverage that corresponds to the code associated with the beverage flavoring capsule 14. The water may be either heated or carbonated prior to dispensing the flavoring fluid from the beverage flavoring capsule 14.

Next, the method 100 moves on to block 104 where a first heater (e.g., heater 38) is operated to heat the beverage flavoring capsule 14 that is disposed with the receptacle 12 according to a first parameter and a second heater (e.g., heater 66) is operated to heat the water in the first path 62 according to a second parameter. The first parameter may comprise heating the beverage flavoring capsule 14 to a temperature that is greater than a threshold or may comprise heating the beverage flavoring capsule 14 for a predetermined period of time. The second parameter may comprise heating the water in the first path 62 to a temperature that is greater than a threshold or may comprise heating the water in the first path 62 for a predetermined period of time.

A first temperature sensor 84 (see FIG. 6) may be disposed proximate or adjacent to the beverage flavoring capsule 14 on the receptacle 12. The first temperature sensor 84 may directly measure the temperature of the beverage flavoring capsule 14 and communicate the directly measured temperature of the beverage flavoring capsule 14 to the controller 80. Alternatively, the first temperature sensor 84 may measure a temperature with the vicinity of the beverage flavoring capsule 14 (e.g., a temperature of the material forming the receptacle 12) and communicate the temperature within the vicinity of the beverage flavoring capsule 14 to the controller 80. The controller 80 may then include an algorithm that estimates the temperature of the beverage flavoring capsule 14 based on the temperature within the vicinity of the beverage flavoring capsule 14.

A second temperature sensor 86 (see FIG. 6) may measure the temperature of the water in the first path 62 and communicate the temperature of the water in the first path 62 to the controller 80. The temperature of the water in the first path 62 may be measured at any position along the first path 62, but is preferably measured at a position that is downstream of the heater 66.

The method 100 next moves on to block 106 where it is determined if the beverage flavoring capsule 14 has been heated according to a first parameter and if the water in the first path 62 has been heated according to a second parameter. If the answer at block 106 is “no” the method 100 recycles back to the beginning of block 106. If the answer at block 106 is “yes” the method 100 moves on to block 108 where the heated beverage flavoring fluid is dispensed from the beverage flavoring capsule 14 via the channel 34 into the container 24 and the heated water is dispensed from the first path 62 via the first outlet 52 into the container 24. More specifically, at block 108, the controller 80 may activate the piston 42 via the actuator 44 to compress the beverage flavoring capsule 14 to dispense the heated beverage flavoring fluid from the beverage flavoring capsule 14 via the channel 34 into the container 24, and the controller 80 may open the first valve 68 to dispense the heated water from the first path 62 via the first outlet 52 into the container 24.

Once the beverage flavoring capsule 14 is heated according to the first parameter via first heater (e.g., heater 38), the controller 80 may be programed to shutdown the first heater. Once water in the first path 62 is heated according to the second parameter via second heater (e.g., heater 66), the controller 80 may be programed to shutdown the second heater. Shutting down either the first heater or the second heater may occur at the transition from block 106 to block 108 or may occur while block 106 is processing and the transition to block 108 has not occurred. This may happen in the event the beverage flavoring capsule 14 has heated according to the first parameter while the water in the first path 62 has not yet heated according to the second parameter, or vice vera. It should be understood that the flowchart in FIG. 7 is for illustrative purposes only and that the method 100 should not be construed as limited to the flowchart in FIG. 7. Some of the steps of the method 100 may be rearranged while others may be omitted entirely.

Typically, once a hot beverage is produced and a beverage flavoring capsule is spent, the residue left within beverage flavoring capsule may amount to 2% of the flavoring fluid. This results in a need to clean the beverage flavoring capsule prior to disposing the capsule in a sustainable manner (e.g., via recycling the plastic comprising the beverage flavoring capsule). An increase in residue occurs at lower temperatures due to an increase in the viscosity of the flavoring fluid at lower temperatures. The system disclosed herein reduces or eliminates such residue by decreasing the viscosity of the flavoring fluid via heating the beverage flavoring capsule prior to dispensation, which in turn eliminates the need to clean the beverage flavoring capsule or significantly reduces the cleaning time of the beverage flavoring capsule.

It should be understood that the designations of first, second, third, fourth, etc. for any component, state, or condition described herein may be rearranged in the claims so that they are in chronological order with respect to the claims. Furthermore, it should be understood that any component, state, or condition described herein that does not have a numerical designation may be given a designation of first, second, third, fourth, etc. in the claims if one or more of the specific component, state, or condition are claimed.

The words used in the specification are words of description rather than limitation, and it is understood that various changes may be made without departing from the spirit and scope of the disclosure. As previously described, the features of various embodiments may be combined to form further embodiments that may not be explicitly described or illustrated. While various embodiments could have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. As such, embodiments described as less desirable than other embodiments or prior art implementations with respect to one or more characteristics are not outside the scope of the disclosure and may be desirable for particular applications.

What is claimed is:

1. A beverage blending device comprising:
a receptacle (i) configured to receive a beverage flavoring capsule and (ii) defining a channel configured route flavoring fluid from the beverage flavoring capsule toward a container;
a cover configured to transition between a first position that covers the receptacle and a second position that exposes the receptacle;
a fluid circuit having an outlet that is disposed proximate to the channel and configured to route water from a source toward the container;
a first heating element disposed within the receptacle and configured to heat the beverage flavoring capsule;
a second heating element disposed along the circuit and configured to heat the water flowing through the circuit; and
a controller programmed to, in response to a command to blend and dispense the flavoring fluid and the water, (i) operate the first heating element to heat the beverage flavoring capsule according to a first parameter, (ii) operate the second heating element to heat the water according to a second parameter, and (iii) subsequent to heating the beverage flavoring capsule and the water according to the first and second parameters, respectively, simultaneously dispense the flavoring fluid and the water into the container via the channel and the outlet, respectively.

2. The beverage blending device of claim 1, wherein the first parameter comprises heating the beverage flavoring capsule to a temperature that is greater than a threshold.

3. The beverage blending device of claim 1, wherein the second parameter comprises heating the water to a temperature that is greater than a threshold.

4. The beverage blending device of claim 1, wherein the first parameter comprises heating the beverage flavoring capsule for a predetermined period of time.

5. The beverage blending device of claim 1, wherein the second parameter comprises heating the water for a predetermined period of time.

6. The beverage blending device of claim 1, wherein the controller is further programmed to, in response to completion of heating the beverage flavoring capsule according to the first parameter, shutdown the first heating element.

7. The beverage blending device of claim 1, wherein the controller is further programmed to, in response to completion of heating the water according to the second parameter, shutdown the second heating element.

8. The beverage blending device of claim 1 further comprising a piston (i) disposed within the receptacle and (ii) configured to compress the beverage flavoring capsule to direct the flavoring fluid out of the beverage flavoring capsule and into the channel.

9. The beverage blending device of claim 8, wherein the controller is configured to activate the piston to compress the beverage flavoring capsule subsequent to heating the beverage flavoring capsule and the water according to the first and second parameters.

10. A beverage maker comprising:
a receptacle (i) configured to receive a flavoring capsule and (ii) defining a channel configured direct a flavoring fluid from the flavoring capsule in a downward direction;
an outlet configured to direct water in the downward direction adjacent to the channel;
a first heater configured to heat the flavoring capsule;
a second heater configured to heat the water; and
a controller programmed to, in response to the receptacle receiving the flavoring capsule and a command to produce a hot beverage, (i) operate the first heater to heat the flavoring capsule according to a first parameter, (ii) operate the second heater to heat the water according to a second parameter, and (iii) dispense the heated flavoring fluid and the heated water via the channel and the outlet, respectively.

11. The beverage maker of claim 10, wherein the first parameter comprises heating the flavoring capsule to a temperature that is greater than a threshold.

12. The beverage maker of claim 10, wherein the second parameter comprises heating the water to a temperature that is greater than a threshold.

13. The beverage maker of claim 10, wherein the first parameter comprises heating the flavoring capsule for a predetermined period of time.

14. The beverage maker of claim 10, wherein the second parameter comprises heating the water for a predetermined period of time.

15. The beverage maker of claim 10 further comprising a piston (i) disposed within the receptacle and (ii) configured to compress the flavoring capsule to direct the flavoring fluid out of the flavoring capsule and into the channel.

16. A beverage maker comprising:
a receptacle configured to receive a flavoring capsule;
a piston configured to compress the flavoring capsule to direct flavoring fluid from the flavoring capsule and into a container via a channel;
a fluid circuit having an outlet configured to direct water into the container adjacent to the channel;
a first heater disposed within the receptacle, and configured to heat the flavoring capsule; and
a second heater disposed along the circuit and configured to heat the water flowing through the circuit.

17. The beverage maker of claim 16 further comprising a controller programmed to, in response to the receptacle receiving the flavoring capsule and a command to produce a hot beverage, (i) operate the first heater to heat the flavoring capsule according to a first parameter, (ii) operate the second heater to heat the water according to a second parameter, and (iii) operate the piston and control the fluid circuit to dispense the heated flavoring fluid and the heated water via the channel and the outlet, respectively.

18. The beverage maker of claim 17, wherein the first parameter comprises heating the flavoring capsule to a temperature that is greater than a threshold.

19. The beverage maker of claim 17, wherein the first parameter comprises heating the flavoring capsule for a predetermined period of time.

20. The beverage maker of claim 17, wherein the first heater is disposed about an internal surface of the receptacle and encompasses the flavoring capsule.
